(19) United States
(12) Patent Application Publication
(10) Pub. No.: US 2011/0200396 A1
(43) Pub. Date: Aug. 18, 2011

(54) SYSTEMS AND METHODS FOR REDUCING DRAG AND/OR VORTEX INDUCED VIBRATION

(76) Inventors: Donald Wayne Allen, Richmond, TX (US); Dean Leroy Henning, Needville, TX (US); Li Lee, Houston, TX (US)

(21) Appl. No.: 12/672,943

(22) PCT Filed: Aug. 11, 2008
(86) PCT No.: PCT/US08/72771

§ 371 Date: Feb. 10, 2010

Related U.S. Application Data
(60) Provisional application No. 60/955,471, filed on Aug. 13, 2007.

(51) Int. Cl. F15D 1/10

(52) U.S. Cl. 405/211

(57) ABSTRACT

A system for reducing drag and/or vortex induced vibration of a structure, the system comprising a multiple sided device comprising from 4 to 6 sides.

### RELATED APPLICATIONS

The present application claims priority to U.S. Provisional Application Ser. No. 60/955,471, filed Aug. 13, 2007, having attorney docket number TH3245. U.S. Provisional Application Ser. No. 60/955,471 is herein incorporated by reference in its entirety.

### FIELD OF THE INVENTION

The present invention relates to systems and methods for reducing drag and/or vortex-induced vibration (“VIV”).

### DESCRIPTION OF THE RELATED ART

Whenever a bluff body, such as a cylinder, experiences a current in a flowing fluid environment, it is possible for the body to experience vortex-induced vibration (VIV). These vibrations may be caused by oscillating dynamic forces on the surface, which can cause substantial vibrations of the structure, especially if the forcing frequency is at or near a structural natural frequency.

Drilling for and/or producing hydrocarbons or the like from subterranean deposits which exist under a body of water exposes underwater drilling and production equipment to water currents and the possibility of VIV. Equipment exposed to VIV includes structures ranging from the smaller tubes of a riser system, anchoring tendons, or lateral pipelines to the larger underwater cylinders of the hull of a mini spar or spar floating production system (hereinafter “spar”).

The magnitude of the stresses on the riser pipe, tendons or spars may be generally a function of and increases with the velocity of the water current passing these structures.

It is noted that even moderate velocity currents in flowing fluid environments acting on linear structures can cause stresses. Such moderate or higher currents may be readily encountered when drilling for offshore oil and gas at greater depths in the ocean or in an ocean inlet or near a river mouth.

There are generally two kinds of current-induced stresses in flowing fluid environments. The first kind of stress may be caused by vortex-induced alternating forces that vibrate the structure (“vortex-induced vibrations”) mainly in a direction perpendicular to the direction of the current. When fluid flows past the structure, vortices may be alternately shed from each side of the structure. This produces a fluctuating force on the structure transverse to the current. If the frequency of this harmonic load is near the resonant frequency of the structure, large vibrations transverse to the current can occur. These vibrations can, depending on the stiffness and the strength of the structure and any welds, lead to unacceptably short fatigue lives. In fact, stresses caused by high current conditions in marine environments have been known to cause structures such as risers to break apart and fall to the ocean floor.

The second type of stress may be caused by drag forces, which push the structure in the direction of the current due to the structure's resistance to fluid flow. The drag forces may be amplified by vortex-induced vibration of the structure. For instance, a riser pipe that is vibrating due to vortex shedding will generally disrupt the flow of water around it more than a stationary riser. This may result in more energy transfer from the current to the riser, and hence more drag.

Many types of devices have been developed to reduce vibrations of sub sea structures. Some of these devices used to reduce vibrations caused by vortex shedding from sub sea structures operate by stabilization of the wake. These methods include use of streamlined fairings, wake splitters and flags.

Devices used to reduce vibrations caused by vortex shedding from sub-sea structures may operate by modifying the boundary layer of the flow around the structure to prevent the correlation of vortex shedding along the length of the structure. Examples of such devices include sleeve-like devices such as helical strakes, shrouds, fairings and substantially cylindrical sleeves.

Elongated structures in wind in the atmosphere can also encounter VIV and/or drag, comparable to that encountered in aquatic environments. Likewise, elongated structures with excessive VIV and/or drag forces that extend far above the ground can be difficult, expensive and dangerous to reach by human workers to install VIV and/or drag reduction devices.

Fairings may be used to suppress VIV and reduce drag acting on a structure in a flowing fluid environment. Fairings may be defined by a chord to thickness ratio, where longer fairings have a higher ratio than shorter fairings. Long fairings are more effective than short fairings at resisting drag, but may be subject to instabilities. Short fairings are less subject to instabilities, but may have higher drag in a flowing fluid environment.

U.S. Pat. No. 6,223,672 discloses an ultrashort fairing for suppressing vortex-induced vibration in substantially cylindrical marine elements. The ultrashort falling has a leading edge substantially defined by the circular profile of the marine element for a distance following at least about 270 degrees thereabout and a pair of shaped sides departing from the circular profile of the marine riser and converging at a trailing edge. The ultrashort fairing has dimensions of thickness and chord length such that the chord to thickness ratio is between about 1.20 and 1.10. U.S. Pat. No. 6,223,672 is herein incorporated by reference in its entirety.

U.S. Pat. No. 4,398,487 discloses a fairing for elongated elements for reducing current-induced stresses on the elongated element. The fairing is made as a stream-lined shaped body that has a nose portion in which the elongated element is accommodated and a tail portion. The body has a bearing connected to it to provide bearing engagement with the elongated element. A biasing device interconnected with the bearing accommodates variations in the outer surface of the elongated element to maintain the fairing's longitudinal axis substantially parallel to the longitudinal axis of the elongated element as the fairing rotates around the elongated element. The fairing is particularly adapted for mounting on a marine drilling riser having flotation modules. U.S. Pat. No. 4,398,487 is herein incorporated by reference in its entirety.

Referring now to FIG. 1, there is illustrated prior art short fairing 104 installed about structure 102. Structure 102 may be subjected to a flowing fluid environment, where short fairing 104 may be used to suppress vortex induced vibration (VIV). Short fairing 104 has chord 106 and thickness 108. Chord to thickness ratio of short fairing 104 may be less than about 1.5, or less than about 1.25. While short fairing 104 is effective at reducing vortex induced vibration, short fairing 104 may be subject to drag forces 110 in a flowing fluid environment.

Referring now to FIG. 2, prior art long fairing 204 is illustrated installed about structure 202. Structure 202 may be in a flowing fluid environment where structure 202 is subject to vortex induced vibration. Compared to short fairing 104, long fairing 204 may have reduced drag when subjected to a flowing fluid environment. Long fairing 204 has chord 206 and thickness 208. Chord to thickness ratio of long fairing 204 may be greater than about 1.7, or greater than about 1.8, greater than about 2.0, or greater than about 2.25. Although long fairing 204 may have lower drag than short fairing 104, long fairing 204 may be subject to flutter, galloping, or a plunge-torsional instability. Long fairing 204 may experience lateral displacement 210 and/or torsional displacement 212.

There are needs in the art for one or more of the following: apparatus and methods for reducing VIV on structures in flowing fluid environments, which do not suffer from certain disadvantages of the prior art apparatus and methods; improved VIV suppression devices; high stability devices; devices which delay the separation of the boundary layer, and/or devices which provide decreased VIV and/or devices which provide reduced drag; devices suitable for use at a variety of fluid flow velocities; devices that can achieve a high degree of VIV suppression with a low coverage density; and/or devices that have a high stability.

These and other needs in the art will become apparent to those of skill in the art upon review of this specification, including its drawings and claims.

### SUMMARY OF THE INVENTION

One aspect of invention provides a system for reducing drag and/or vortex induced vibration of a structure, the system comprising a multiple sided device comprising from 4 to 6 sides.

Another aspect of invention provides a method for modifying a structure subject to drag and/or vortex induced vibration, said method comprising positioning at least one multiple sided device around the structure, the multiple sided device comprising from 4 to 6 sides.

Advantages of the invention may include one or more of the following: improved VIV reduction; improved device stability; delaying the separation of the boundary layer over the device body; lower cost devices; devices that are easier to install; and/or lighter weight devices.

These and other aspects of the invention will become apparent to those of skill in the art upon review of this specification, including its drawings and claims.

### BRIEF DESCRIPTION OF THE DRAWINGS

FIG. 1 shows a prior art short fairing.

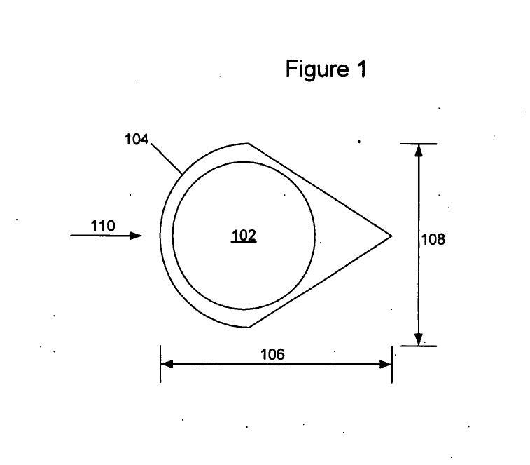

FIG. 2 shows a prior art long fairing.

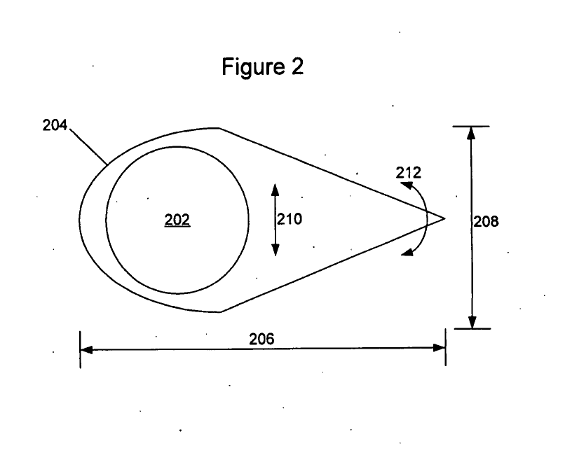

FIG. 3 shows a three-sided VIV suppression device.

FIG. 4 shows a four-sided VIV suppression device.

FIG. 5 shows a six-sided VIV suppression device.

FIG. 6 shows a plurality of VIV suppression devices installed along the length of a structure.

### DETAILED DESCRIPTION OF THE INVENTION

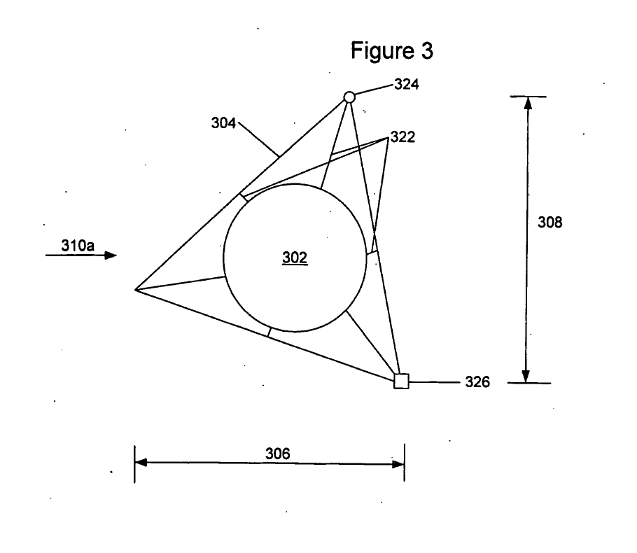

FIG. 3:

Referring now to FIG. 3, multiple sided device 304 is illustrated. Device 304 is shown installed about structure 302. Structure 302 may be in a flowing fluid environment with flow 310a, where structure 302 is subject to vortex induced vibration. Device 304 may be used to suppress the vortex induced vibration of structure 302.

Device 304 has chord 306 and thickness 308, which may vary if device 304 rotates relative structure 302. Chord 306 is measured parallel to flow 310a, and thickness 308 is measured perpendicular to flow 310a. Chord to thickness ratio of device 304 as shown in FIG. 3 may be less than about 1.5, or less than about 1.25, or less than about 1.1, for example about 1. Chord to thickness ratio of device 304 as shown in FIG. 3 may be greater than about 0.6, or greater than about 0.75, or greater than about 0.9, for example about 1.

Device 304 may be subject to fluid flow 310a. Device 304 includes three sides and brace members 322 connected to the sides. Device 304 may include hinge 324 and latch 326 to open and close device 304.

All of the sides may have the same length, two of the sides may have the same length, or each side may have a different length. The sides may be substantially straight, or may have a slight convex or concave curvature. Each of the sides may have a length from about 1.25 to about 3 times a diameter of structure 302, for example from about 1.5 to about 2 times, or about 1.75 times.

The sides may make an angle from about 30 to about 150 degrees with each other, for example from about 45 to about 120 degrees, or from about 50 to about 90 degrees, or about 60 degrees.

Device 304 may be able to rotate about structure 302, or it may be in a fixed angular orientation. Device 304 may have a collar mounted above and/or below device 304 to secure device at a fixed location along the length of structure 302 and/or to provide a bearing surface for device 304 to rotate.

Device 304 may be molded, welded, bent, cast, glued, or otherwise formed with manufacturing techniques as are known in the art. Device 304 may be made of metals such as steel or aluminum, polymers such as polyethylene or polypropylene, or composite materials such as fiberglass or carbon fiber composites, or other materials as are known in the art.

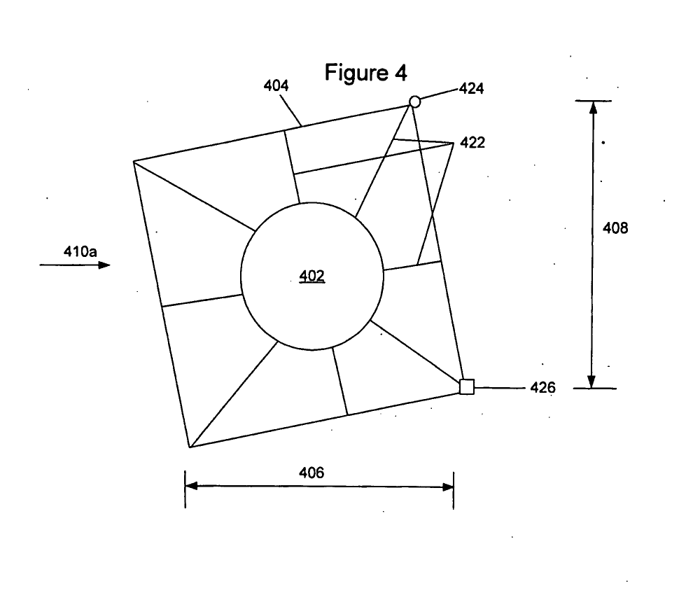

FIG. 4:

Referring now to FIG. 4, multiple sided device 404 is illustrated. Device 404 is shown installed about structure 402. Structure 402 may be in a flowing fluid environment with flow 410a, where structure 402 may be subject to vortex induced vibration. Device 404 may be used to suppress the vortex induced vibration of structure 402.

Device 404 has chord 406 and thickness 408, which may vary if device 404 rotates relative structure 402. Chord 406 is measured parallel to flow 410a, and thickness 408 is measured perpendicular to flow 410a. Chord to thickness ratio of device 404 as shown in FIG. 4 may be less than about 1.5, or less than about 1.25, or less than about 1.1, for example about 1. Chord to thickness ratio of device 404 as shown in FIG. 4 may be greater than about 0.6, or greater than about 0.75, or greater than about 0.9, for example about 1.

Device 404 may be subject to fluid flow 410a. Device 404 includes four sides and brace members 422 connected to the sides. Device 404 may include hinge 424 and latch 426 to open and close device 404.

All of the sides may have the same length, three of the sides may have the same length, two of the sides may have the same length, or each side may have a different length. The sides may be substantially straight, or may have a slight convex or concave curvature. Each of the sides may have a length from about 0.75 to about 4 times a diameter of structure 402, for example from about 0.9 to about 2 times, or from about 1 to about 1.5 times, or about 1.25 times.

The sides may make an angle from about 30 to about 150 degrees with each other, for example from about 60 to about 120 degrees, or from about 75 to about 105 degrees, or about 90 degrees.

Device 404 may be a square, a rectangle, a parallelogram, a trapezoid, or a diamond shape.

Device 404 may be able to rotate about structure 402, or it may be in a fixed angular orientation. Device 404 may have a collar mounted above and/or below device 404 to secure device at a fixed location along the length of structure 402 and/or to provide a bearing surface for device 404 to rotate.

Device 404 may have two sides aligned substantially parallel with flow 510a.

Device 404 may be molded, welded, bent, cast, glued, or otherwise formed with manufacturing techniques as are known in the art. Device 404 may be made of metals such as steel or aluminum, polymers such as polyethylene or polypropylene, or composite materials such as fiberglass or carbon fiber composites, or other materials as are known in the art.

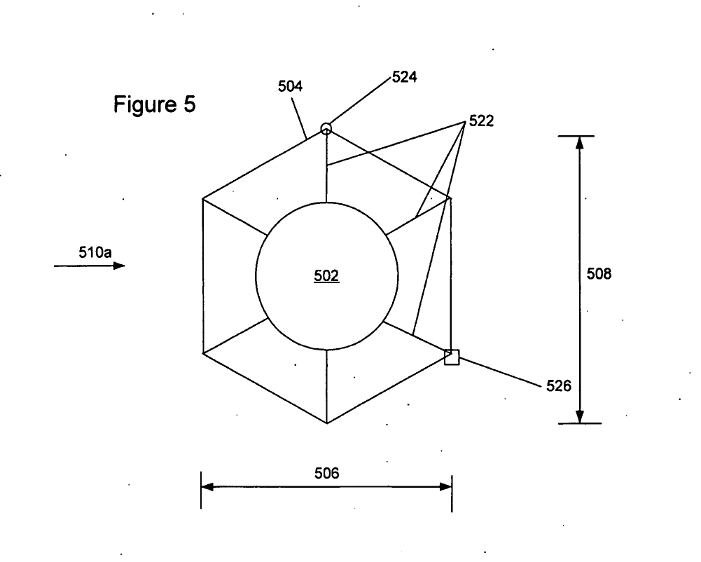

FIG. 5:

Referring now to FIG. 5, multiple sided device 504 is illustrated. Device 504 is shown installed about structure 502. Structure 502 may be in a flowing fluid environment with flow 510a, where structure 502 may be subject to vortex induced vibration. Device 504 may be used to suppress the vortex induced vibration of structure 502.

Device 504 has chord 506 and thickness 508, which may vary if device 504 rotates relative structure 502. Chord 506 is measured parallel to flow 510a, and thickness 508 is measured perpendicular to flow 510a. Chord to thickness ratio of device 504 as shown in FIG. 5 may be less than about 1.5, or less than about 1.25, or less than about 1.1, for example about 1. Chord to thickness ratio of device 504 as shown in FIG. 5 may be greater than about 0.6, or greater than about 0.75, or greater than about 0.9, for example about 1.

Device 504 may be subject to fluid flow 510a. Device 504 includes six sides and brace members 522 connected to the sides. Device 504 may include hinge 524 and latch 526 to open and close device 504.

All of the sides may have the same length, five of the sides may have the same length, four of the sides may have the same length, three of the sides may have the same length, two of the sides may have the same length, or each side may have a different length. The sides may be substantially straight, or may have a slight convex or concave curvature. Each of the sides may have a length from about 0.1 to about 2 times a diameter of structure 502, for example from about 0.25 to about 1.5 times, or from about 0.5 to about 1.25 times, or about 1 times.

The sides may make an angle from about 30 to about 175 degrees with each other, for example from about 60 to about 160 degrees, or from about 75 to about 140 degrees, or about 120 degrees.

Device 504 may be able to rotate about structure 502, or it may be in a fixed angular orientation. Device 504 may have a collar mounted above and/or below device 504 to secure device at a fixed location along the length of structure 502 and/or to provide a bearing surface for device 504 to rotate.

Device 504 may have two sides aligned substantially parallel with flow 510a.

Device 504 may be molded, welded, bent, cast, glued, or otherwise formed with manufacturing techniques as are known in the art. Device 504 may be made of metals such as steel or aluminum, polymers such as polyethylene or polypropylene, or composite materials such as fiberglass or carbon fiber composites, or other materials as are known in the art.

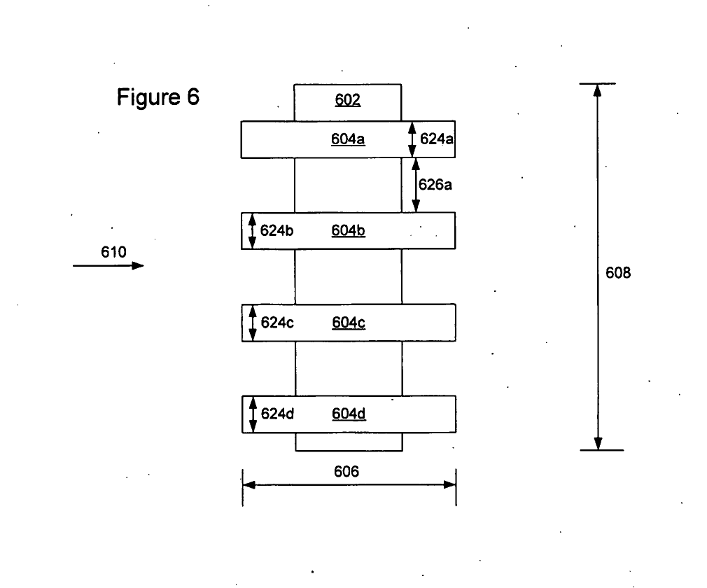

FIG. 6:

Referring now to FIG. 6, structure 602 is illustrated with a plurality of multiple sided devices 604a, 604b, 604c, and 604d installed about structure 602 in order to suppress vortex induced vibration of structure 602, when structure 602 is subjected to fluid flow 610. In some embodiments, collars may be provided between adjacent devices or placed between every few devices. In some embodiments, devices 604a-604d may be installed before structure is installed, for example in a subsea environment. In some embodiments, devices 604a-604d may be installed as a retrofit installation to structure 602 which has already been installed, for example in a subsea environment.

Device 604a has height 624a and distance 626a between adjacent devices 604a and 604b. Device 604a has length 606. Portion of structure 602 covered with devices 604a-604d has height 608. Device 604b has height 624b, device 604c has height 624c, and device 604d has height 624d.

Devices 604a-604d may cover from about 10% to about 100% of height 608, for example from about 20% to about 80%, or from about 30% to about 50%.

Length 606 may be from about 1.25 times the diameter of structure 602 to about 3 times, for example from about 1.5 to about 2 times the diameter.

Height 624a may be from about 1 times the diameter of structure 602 to about 6 times, for example from about 1.25 to about 3 times the diameter, or from about 1.5 to about 2 times the diameter.

Distance 626a may be from about 1 times the diameter of structure 602 to about 10 times, for example from about 1.5 to about 6 times the diameter, or from about 2 to about 4 times the diameter.

### Illustrative Embodiments

In one embodiment, there is disclosed a system for reducing drag and/or vortex induced vibration of a structure, the system comprising a multiple sided device comprising from 4 to 10 sides. In some embodiments, the device comprises a chord to thickness ratio of less than 1.5. In some embodiments, the device comprises a chord to thickness ratio of less than 1.25. In some embodiments, the device is installed about the structure. In some embodiments, the device comprises from 4 to 6 sides. In some embodiments, the device comprises 4 sides. In some embodiments, the device comprises 2 sides aligned substantially parallel with a fluid flow encountering the structure. In some embodiments, the device comprises an even number of sides. In some embodiments, the device comprises a square shape. In some embodiments, the system also includes a plurality of multiple sided devices along a length of the structure.

In one embodiment, there is disclosed a method for modifying a structure subject to drag and/or vortex induced vibration, said method comprising positioning at least one multiple sided device around the structure, the multiple sided device comprising from 4 to 10 sides. In some embodiments, the positioning comprises positioning at least two multiple sided devices about the structure. In some embodiments, the method also includes positioning a collar, a buoyancy module, and/or a clamp around the structure. In some embodiments, the device comprises a four sided shape. In some embodiments, the method also includes locking the device at a preferred angular orientation based on ambient expected currents acting on the structure.

The VIV systems and methods disclosed herein may be used in any flowing fluid environment in which the structural integrity of the system can be maintained. The term, “flowing-fluid” is defined here to include but not be limited to any fluid, gas, or any combination of fluids, gases, or mixture of one or more fluids with one or more gases, specific non-limiting examples of which include fresh water, salt water, air, liquid hydrocarbons, a solution, or any combination of one or more of the foregoing. The flowing-fluid may be “aquatic,” meaning the flowing-fluid comprises water, and may comprise seawater or fresh water, or may comprise a mixture of fresh water and seawater.

In some embodiments, devices of the invention may be used with most any type of offshore structure, for example, bottom supported and vertically moored structures, such as for example, fixed platforms, compliant towers, tension leg platforms, and mini-tension leg platforms, and also include floating production and subsea systems, such as for example, spar platforms, floating production systems, floating production storage and offloading, and subsea systems.

In some embodiments, devices may be attached to marine structures such as subsea pipelines; drilling, production, import and export risers; tendons for tension leg platforms; legs for traditional fixed and for compliant platforms; space-frame members for platforms; cables; umbilicals; mooring elements for deepwater platforms; and the hull and/or column structure for tension leg platforms (TLPs) and for spar type structures. In some embodiments, device may be attached to spars, risers, tethers, and/or mooring lines.

In some embodiments, the multiple sided device may be formed as a hollow plastic moulding whose interior communicates with the exterior to permit equalization of pressure. In some embodiments, the multiple sided device may be formed by a single plastic moulding, such as by rotational moulding, so that it may be hollow. The multiple sided device may be manufactured of polythene, which may be advantageous due to its low specific gravity (similar to that of water), toughness and low cost. Openings may be provided to allow water to enter the multiple sided device to equalize internal and external pressures. The multiple sided device could also be formed as a solid polyurethane moulding. In some embodiments, the principal material used in constructing the multiple sided device may be fiberglass. Other known materials may also be used which have suitable weight, strength and corrosion-resistant characteristics. In some embodiments, the multiple sided device may be constructed from any metallic or non-metallic, low corrosive material such as a aluminum or multi-layer fiberglass mat, polyurethane, vinyl ester resin, high or low density polyurethane, PVC or other materials with substantially similar flexibility and durability properties. These materials provide the multiple sided device with the strength to stay on the structure, but enough flex to allow it to be snapped in place during installation. The fiberglass may be 140-210 MPa tensile strength (for example determined with ISO 527-4) that may be formed as a bi-directional mat or the multiple sided device can be formed of vinyl ester resin with 7-10% elongation or polyurethane. The use of such materials eliminates the possibility of corrosion, which can cause the multiple sided device shell to seize up around the elongated structure it surrounds.

Collars may be provided to connect the multiple sided device to the structure and/or to provide spacing between adjacent multiple sided devices along the structure. Collars may be formed by a single plastics moulding, such as nylon, or from a metal such as stainless steel, copper, or aluminum. In some embodiments, the internal face of the collar's bearing ring may serve as a rotary bearing allowing the multiple sided device to rotate about the structure's longitudinal axis and so to weathervane to face a current. Only the collar may make contact with the structure, its portion interposed between the multiple sided device and the structure serving to maintain clearance between these parts. This bearing surface may be (a) low friction and even “self lubricating” and/or (b) resistant to marine fouling. These properties can be promoted by incorporation of anti-fouling and/or friction reducing materials into the material of the collar. The material of the collar may contain a mixture of an anti-fouling composition which provides a controlled rate of release of copper ions, and/or also of silicon oil serving to reduce bearing friction.

In some embodiments, there may not be provided a collar, and the multiple sided device may be mounted to the structure itself. That is, the multiple sided device may be mounted directly upon the structure (or on a cylindrical protective sheath conventionally provided around the structure). A number of such multiple sided devices may be placed adjacent one another in a string along the structure. To prevent the multiple sided devices from moving along the length of the structure, clamps and/or collars may secured to the structure at intervals, for example between about every one to five multiple sided devices. The clamps and/or collars may be of a type having a pair of half cylindrical clamp shells secured to the structure by a tension band passed around the shells.

In some embodiments, the multiple sided device may be designed so that it can freely rotate about the structure in order to provide more efficient handling of the wave and current action and VIV bearing on the structure. The multiple sided devices may not be connected, so they can rotate relative to each other. Bands of low-friction plastic rings, for example a molybdenum impregnated nylon, may be connected to the inside surface of the multiple sided device that defines an opening to receive the structure. A low friction material may be provided on the portion of the multiple sided device that surrounds a structure, for example strips of molydbodeum impregnated nylon, which may be lubricated by sea water.

In some embodiments, a first retaining ring, or thrust bearing surface, may be installed above and/or below each multiple sided device or group of multiple sided devices. Buoyancy cans may also be installed above and/or below each multiple sided device or group of multiple sided devices.

The methods and systems of the invention may further comprise modifying the buoyancy of the multiple sided device. This may be carried out by attaching a weight or a buoyancy module to the multiple sided device. In some embodiments, the multiple sided device may include filler material that may be either neutrally or partially buoyant. The multiple sided device may be partially filled with a known syntactic foam material for making the device partially buoyant in sea water. This foam material can be positively buoyant or neutrally buoyant for achieving the desired results.

In some embodiments, at least one copper element may be mounted at the structure and/or the multiple sided device to discourage marine growth at the device—structure interface so that the device remains free to weathervane to orient most effectively with the current, for example a copper bar. In some embodiments, the multiple sided devices may be made of copper, or be made of copper and one or more other materials.

The height of the multiple sided device can vary considerably depending upon the specific application, the materials of construction, and the method employed to install the multiple sided device. In extended marine structures, numerous devices may be placed along the length of the marine structure, for example covering from about 15% or 25%, to about 50%, or 75%, or 100% of the length of the marine structure with the devices.

In some embodiments, multiple sided devices may be placed on a marine structure after it is in place, for example, suspended between a platform and the ocean floor, in which divers or submersible vehicles may be used to fasten the multiple devices around the structure. Alternatively, devices may be fastened to the structure as lengths of the structure are assembled. This method of installation may be performed on a specially designed vessel, such as an S-Lay or J-Lay barge, that may have a declining ramp, positioned along a side of the vessel and descending below the ocean's surface, that may be equipped with rollers. As the lengths of the structure are fitted together, multiple sided devices may be attached to the connected sections before they are lowered into the ocean.

The multiple sided devices may comprise one or more members. Examples of two-membered devices suitable herein include a clam-shell type structure wherein the device comprises two members that may be hinged to one another to form a hinged edge and two unhinged edges, as well as a device comprising two members that may be connected to one another after being positioned around the circumference of the marine structure. Optionally, friction-reducing devices may be attached to the interior surface of the device.

Clam-shell devices may be positioned onto the marine structure by opening the clam shell device, placing the device around the structure, and closing the clam-shell device around the circumference of the structure. The step of securing the device into position around the structure may comprise connecting the two members to one another. For example, the device may be secured around the structure by connecting the two unhinged edges of the clam shell structure to one another. Any connecting or fastening device known in the art may be used to connect the member to one another.

In some embodiments, clamshell type devices may have a locking mechanism to secure the device about the structure, such as male-female connectors, rivets, screws, adhesives, welds, and/or connectors.

Of course, it should be understood that the above attachment apparatus and methods are merely illustrative, and any other suitable attachment apparatus may be utilized.

In some embodiments, devices may include one or more wake splitter plates. In some embodiments, devices may include one or more stabilizer fins.

The methods and systems of the invention may further comprise positioning a second device, or a plurality of devices around the circumference of a structure.

In the multi-device embodiments, the devices may be adjacent one another on the structure, or stacked on the structure. The devices may comprise end flanges, rings or strips to allow the devices to easily stack onto one another, or collars or clamps may be provided in between devices or groups of devices. In addition, the devices may be added to the structure one at a time, or they may be stacked atop one another prior to being placed around/onto the structure. Further, the devices of a stack of devices may be connected to one another, or attached separately.

While the devices have been described as being used in aquatic environments, they may also be used for VIV and/or drag reduction on elongated structures in atmospheric environments.

### Examples

A 4.5 inch outside diameter pipe have a length of 12.2 feet was secured in a current tank and exposed to currents from 2.5 up to 7.5 feet per second water flow. A bare pipe and a number of different multiple sided devices were attached to the pipe, and the drag and acceleration were measured and recorded.

The results of the experiments are presented below:

### Devices with Different Number of Sides

| | # of | max | averaged | device | device |
|---|---|---|---|---|---|
| | sides | rms A/D | drag | height (in) | mat'l |
| bare pipe | 0 | 0.67 | 0.65 | N/a | N/a |
| triangle | 3 | 0.68 | 4.1 | 13.5 | aluminum |
| square | 4 | 0.198 | 1.53 | 13.5 | aluminum |
| pentagon | 5 | 0.376 | 1.69 | 13.5 | aluminum |

### Devices with Different Heights

| | Device height | Device | max | averaged |
|---|---|---|---|---|
| | (diameters) | height (in) | rms A/D | drag |
| bare pipe | N/a | N/a | 0.67 | 0.65 |
| square | 1D | 4.5 | 0.16 | 1.32 |
| square | 2D | 9 | 0.23 | 1.49 |
| square | 3D | 13.5 | 0.20 | 1.53 |
| square | 6D | 27 | 0.19 | 1.58 |

Square Device (7.75 in Tall) with Different Vertical Spacing Between them

| | spacing, D's | max rms A/D | averaged drag |
|---|---|---|---|
| bare pipe | N/a | 0.67 | 0.65 |
| square | 4 | 0.173 | 0.7 |
| square | 6 | 0.142 | 0.64 |
| square | 8 | 0.29 | na |

Square Device (4.5 in Tall) with Different Spacing Between them

| | spacing, D's | max rms A/D | averaged drag |
|---|---|---|---|
| bare pipe | N/a | 0.67 | 0.65 |
| square | 0 | 0.16 | 1.32 |
| square | 1 | 0.023 | 1.07 |
| square | 1.5 | 0.037 | 0.93 |
| square | 2 | 0.076 | 0.83 |
| square | 3 | 0.086 | 0.73 |
| square | 4 | 0.169 | 0.65 |
| square | 5 | 0.229 | 0.6 |
| square | 6 | 0.227 | 0.58 |

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which this invention pertains.

1. A system for reducing drag and/or vortex induced vibration of a structure, the system comprising:
a multiple sided device comprising from 4 to 6 sides.

2. The system of claim 1, wherein the device comprises a chord to thickness ratio of less than 1.5.

3. The system of claim 1, wherein the device comprises a chord to thickness ratio of less than 1.25.

4. The system of claim 1, wherein the device is installed about the structure.

5. The system of claim 1, wherein the device comprises a height from 0.5 to 10 times a diameter of the structure.

6. The system of claim 1, wherein the device comprises 4 sides.

7. The system of claim 1, wherein the device comprises 2 sides aligned substantially parallel with a fluid flow encountering the structure.

8. The system of claim 1, wherein the device comprises an even number of sides.

9. The system of claim 1, wherein the device comprises a square shape.

10. The system of claim 1, further comprising a plurality of multiple sided devices along a length of the structure.

11. The system of claim 1, further comprising at least 3 corners, each corner having a radius of curvature less than a radius of the structure.

12. A method for modifying a structure subject to drag and/or vortex induced vibration, said method comprising:
positioning at least one multiple sided device around the structure, the multiple sided device comprising from 4 to 6 sides.

13. The method of claim 12, wherein the positioning comprises positioning at least two multiple sided devices about the structure.

14. The method of claim 12, further comprising:
positioning a collar, a buoyancy module, and/or a clamp around the structure.

15. The method of claim 12, wherein the device comprises a four sided shape.

16. The method of claim 12, further comprising:
locking the device at a preferred angular orientation based on ambient expected currents acting on the structure.

17. A system for reducing drag and/or vortex induced vibration of a structure, the system comprising:
a multiple sided device comprising from 4 to 10 sides, the device free to rotate about the structure.

18. The system of claim 17, wherein the device comprises a chord to thickness ratio of less than 1.5.

19. The system of claim 17, wherein the device comprises a chord to thickness ratio of less than 1.25.

20. The system of claim 17, further comprising one or more thrust collars located about the structure, above and/or below the device.

21. The system of claim 17, wherein the device comprises a height from 0.5 to 10 times a diameter of the structure.

22. The system of claim 17, wherein the device comprises 4 sides.

23. The system of claim 17, wherein the device comprises 2 sides aligned substantially parallel with a fluid flow encountering the structure.

24. The system of claim 17, wherein the device comprises an even number of sides.

25. The system of claim 17, wherein the device comprises a square shape.

26. The system of claim 17, further comprising a plurality of multiple sided devices along a length of the structure.

27. The system of claim 17, further comprising at least 3 corners, each corner having a radius of curvature less than a radius of the structure.
